(19) United States
(12) Patent Application Publication
(10) Pub. No.: US 2003/0193727 A1
(43) Pub. Date: Oct. 16, 2003

(54) Detecting head-disc interference using position error signal

(75) Inventors: Louis J. Fioravanti, Boulder, CO (US); Joseph A. Wood, Longmont, CO (US); Hai T. Ho, Broomfield, CO (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 10/215,907

(22) Filed: Aug. 8, 2002

Related U.S. Application Data
(60) Provisional application No. 60/372,515, filed on Apr. 11, 2002.

(51) Int. Cl. G11B 27/36; G11B 21/02

(52) U.S. Cl. 360/31; 360/75

(57) ABSTRACT

A method of detecting and quantifying head-disc interference in a disc drive includes obtaining a position error signal representing deviation of a head from a track on a disc in the disc drive. A portion of the position error signal is analyzed to produce a signal value that corresponds to a level of head-disc interference in the disc drive. The signal value is compared to a predetermined benchmark value. A head-disc interference detection system is adapted to detect and quantify contact between discs and heads positioned over data surfaces of the discs in disc drives. The system includes a disc drive including a disc and a head positioned over a data surface of the disc. The head is able to produce a position error signal representing deviation of the head from a track of the data surface. The detection system is able to analyze magnitudes of the position error signal to produce a signal value. The detection system is also able to compare the signal value to a predetermined benchmark value.

### RELATED APPLICATIONS

This application claims priority of U.S. provisional application Serial No. 60/372,515, filed Apr. 11, 2002.

### FIELD OF THE INVENTION

This application relates generally to disc drives and more particularly to detecting contact between a head and a disc in a disc drive.

### BACKGROUND OF THE INVENTION

A disc drive typically includes one or more discs that rotate at a constant high speed during operation of the drive. Information is written to and read from tracks on the discs through the use of an actuator assembly, which rotates during a seek operation. A typical actuator assembly includes a plurality of actuator arms, which extend towards the discs, with one or more flexures extending from each of the actuator arms. Mounted at the distal end of each of the flexures is a head, which acts as an air bearing slider enabling the head to fly in close proximity above the corresponding surface of the associated disc.

Increasing the density of information stored on discs can increase the storage capacity of hard disc drives. To read the densely stored information, designers have decreased the gap fly height between the heads and the discs. Reducing the gap fly height can lead to increased contact between the head and the data portion of the disc during operation of the disc drive (i.e., head-disc interference). Such interference can excite head and disc resonance frequencies, which can interfere with the servo positioning of the recording heads over the data tracks. For example, if head-disc interference occurs during a servo track writing operation, then spurious vibrations may be written into the servo pattern due to the excitation of head and disc resonance modes. Head-disc interference can also lead to accelerated head and disc surface wear. This may culminate in a “head crash,” a phenomena where the recording head irreparably damages the disc surface, resulting in loss of data and catastrophic disc drive failure.

Head-disc interference has typically been detected using acoustic emission sensors. A standard acoustic emission sensor has a piezoelectric sensing element, which detects head, gimbal, and suspension resonance vibration modes that are excited when the heads contact the disc surfaces. These sensors are typically attached to the actuator arms as close to the recording heads as possible. Thus, they add mass to the actuator arms. Additionally, the disc drive must be opened and adhesives employed to adhere the sensors to the actuator arms. This procedure may result in contamination of the sealed area of the disc drive.

Accordingly there is a need for detecting head-disc interference without adding mass to the actuator arms or contaminating the disc drive environment. The present invention provides a solution to this and other problems, and offers other advantages over the prior art.

### SUMMARY OF THE INVENTION

Against this backdrop the present invention has been developed. An embodiment of the present invention is a method of detecting and quantifying head-disc interference in a disc drive. The method includes obtaining a position error signal representing deviation of a head from a track on a disc in the disc drive. A portion of the position error signal is analyzed to produce a signal value that corresponds to a level of head-disc interference in the disc drive. The signal value is compared to a predetermined benchmark value, thereby quantifying head-disc interference in the disc drive.

Stated another way, an embodiment of the present invention is a method of detecting and quantifying head-disc interference. The method includes obtaining a position error signal representing deviation of a head from a track of a data surface of a disc and isolating a non-repeatable runout component of the position error signal. A portion of the non-repeatable runout component is analyzed to produce a signal value, and the signal value is compared to a predetermined benchmark value, thereby quantifying head-disc interference in the disc drive.

Stated yet another way, an embodiment of the present invention is a head-disc interference detection system adapted to detect and quantify contact between discs and heads positioned over data surfaces of the discs in disc drives. The system includes a disc drive including a disc and a head positioned over a data surface of the disc. The head is able to produce a position error signal representing deviation of the head from a track of the data surface. The detection system is able to analyze magnitudes of the position error signal to produce a signal value. The detection system is also able to compare the signal value to a predetermined benchmark value, thereby quantifying head-disc interference in the disc drive.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a schematic diagram of a head-disc interference detection system in accordance with a preferred embodiment of the present invention.

FIG. 3 is a flow chart depicting a process flow for detecting and quantifying head-disc interference in accordance with a preferred embodiment of the present invention.

FIG. 4 is a diagram illustrating a head path including no runout, a head path including only repeatable runout, and a head path including both repeatable and non-repeatable runout.

FIG. 5 is a chart depicting the non-repeatable runout component of a position error signal with a disc drive operating in an environment having a pressure equivalent to atmospheric pressure at sea level.

FIG. 6 is a chart similar to FIG. 5, but with the disc drive operating in an environment having a pressure equivalent to atmospheric pressure at 5,000 feet above sea level.

FIG. 7 is a chart similar to FIG. 5, but with the disc drive operating in an environment having a pressure equivalent to atmospheric pressure at 10,000 feet above sea level.

FIG. 8 is a chart similar to FIG. 5, but with the disc drive operating in an environment having a pressure equivalent to atmospheric pressure at 13,000 feet above sea level.

FIG. 9 is a flow chart depicting in detail a process flow for detecting head-disc interference in accordance with a preferred embodiment of the present invention.

### DETAILED DESCRIPTION

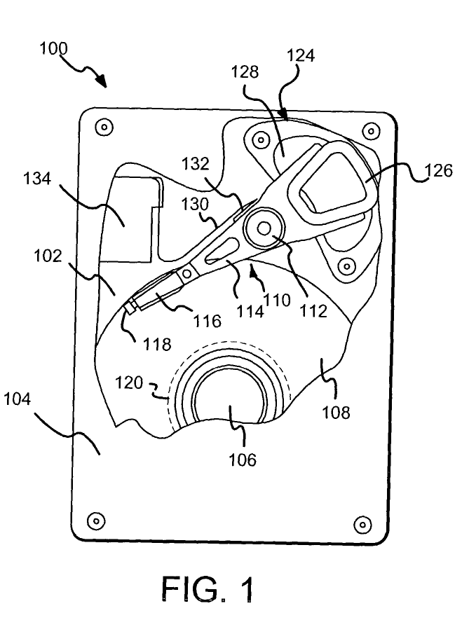

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106, which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118, which includes an air bearing slider enabling the head 118 to fly in close proximity above the corresponding surface of the associated disc 108.

During a seek operation, the track position of the heads 118 is controlled through the use of a voice coil motor 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved over park zones 120 near the inner diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

Embodiments of the present invention may be implemented either through hardware, i.e., logic devices, or as a computer-readable program storage device which tangibly embodies a program of instructions executable by a disc drive 100 or other computer system for detecting and quantifying head-disc interference using position error signals. As such, the logical operations of the various embodiments of the present invention may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

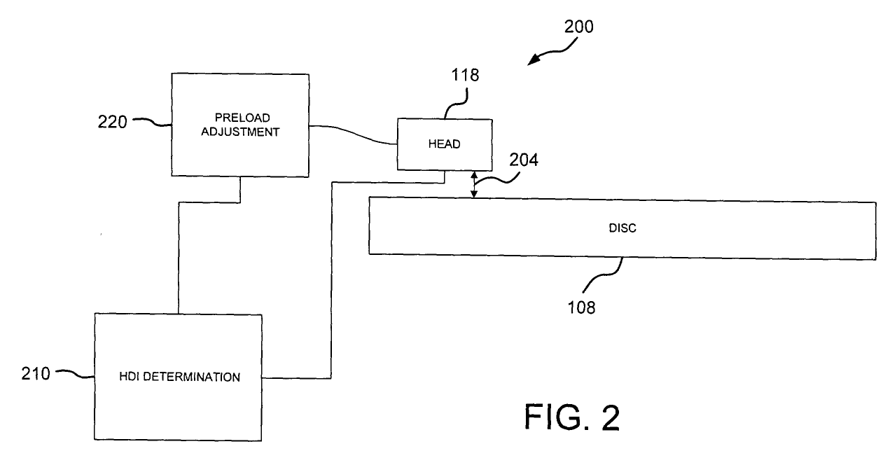

FIG. 2 depicts a system 200 for detecting and quantifying head-disc interference (i.e., contact between a head and data surface of a disc while the disc drive is operating). The head-disc interference detection system 200 includes a disc 108 and a head 118 flying at a fly height 204 over the disc 108. While the head 118 is generally flying at a particular fly height 204, it may come into contact with the disc 108 for various reasons, but particularly if the fly height 204 is too small.

A head-disc interference determination module 210 receives a position error signal, which represents the deviation of the head 118 from a track of the disc 108. The head-disc interference determination module 210 uses the position error signal to determine whether the level of head-disc interference is too great. A preload adjustment module 220 can then adjust the fly height 204 by adjusting the preload on the head 118 (i.e., a force between the head 118 and the disc 108 when the head 118 is resting on the disc 108). Alternatively, the fly height 204 can be adjusted by replacing the head 118. Preload adjustment may be done, for example, by heating a portion of the flexure 116 that supports the head 118. The head-disc interference determination module 210 may again determine whether the level of interference between the head 118 and the disc 108 is too great. This iterative process may continue until a desired fly height 204 is achieved.

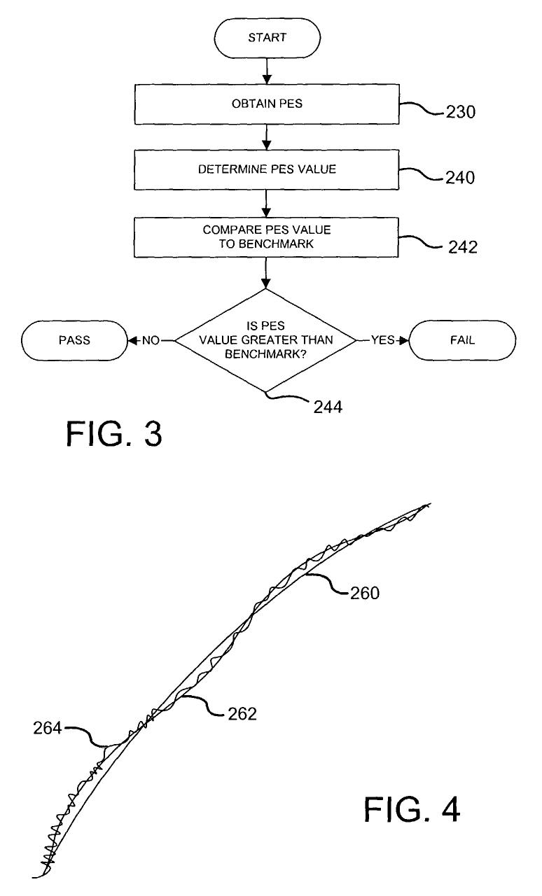

A process flow for determining whether the level of interference between the head 118 and the disc 108 is too great is depicted in FIG. 3. In obtain position error signal operation 230, a position error signal is received from the subject head 118. A value of the position error signal is then determined in determine position error signal value operation 240. The position error signal value is preferably a statistical summation of at least a portion of the position error signal, although it could be some other value calculated from the position error signal, such as a peak value at a specific frequency.

The position error signal value is compared to a benchmark value in compare operation 242. The benchmark value is preferably such that position error signal values above the benchmark value indicate unacceptable levels of head-disc interference and position error signal values below the benchmark value indicate acceptable levels of head-disc interference. Benchmark query operation 244 determines whether the position error signal value is above or below the benchmark value. If the position error signal value is above the benchmark value, then the disc drive 100 fails, indicating that the level of head-disc interference between the head 118 and the disc 108 is too great. Such a disc drive 100 has a high likelihood of a head crash or similar problems and can be scrapped, or more preferably reworked by adjusting the preload on the head 118 or replacing the head 118.

The position error signal typically includes both repeatable and non-repeatable runout components. FIG. 4 illustrates what is meant by repeatable and non-repeatable runout components. As a head 118 travels over a disc 108, the head 118 will stray from an ideal track path 260. A repeatable runout track path 262 depicts the path of a head 118 if it had only repeatable runout and no non-repeatable runout. The deviation due to the repeatable runout is repeated on each revolution of the disc 108. An actual track path 264 illustrates the actual path followed by the head 118, including the repeatable and non-repeatable runout components. The non-repeatable runout component is not repeated on each revolution, and often results from vibrations in the disc drive 100.

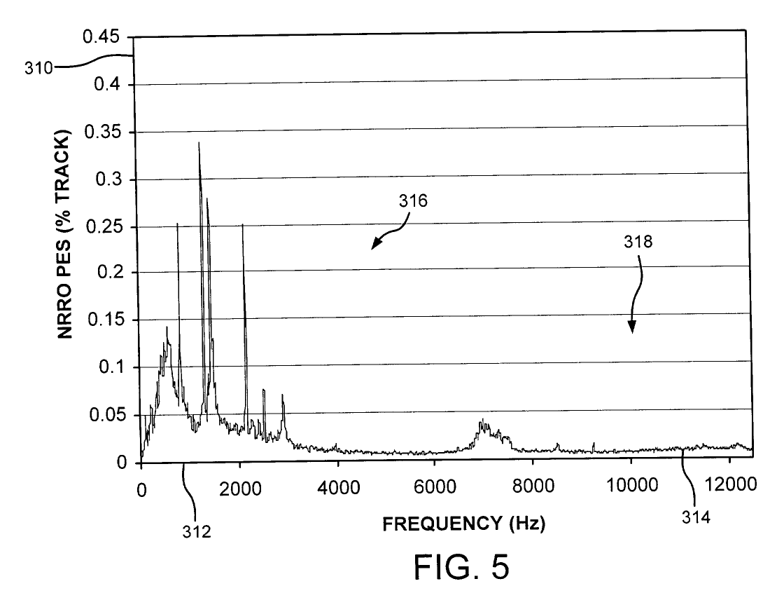

Vibrations caused by head-disc interference are manifest most clearly in the non-repeatable component of the position error signal. FIGS. 5-8 illustrate the effects of head-disc interference on the non-repeatable runout component of the position error signal. FIGS. 5-8 illustrate the non-repeatable runout position error signals in the frequency domain for a disc drive operating in each of four different environmental pressures: a pressure equivalent to typical atmospheric pressure at sea level, a pressure equivalent to typical atmospheric pressure at 5,000 ft above sea level, a pressure equivalent to typical atmospheric pressure at 10,000 ft above sea level, and a pressure equivalent to typical atmospheric pressure at 13,000 ft above sea level.

Each chart in FIGS. 5-8 includes a vertical axis 310 that represents the non-repeatable runout component of the position error signal, and a horizontal axis 312 that represents frequency. As shown in FIG. 5, a sea level magnitude line 314 represents the non-repeatable runout component of the position error signal when operating the disc drive 100 in a sea level equivalent pressure environment. The sea level magnitude line 314 includes a low frequency portion 316 having several sharp peaks below 4,000 Hz and an increase at about 7,000 Hz. However, the sea level magnitude line 314 is stable with no significant increases along a high frequency portion 318 from 8,000 Hz to above 12,000 Hz.

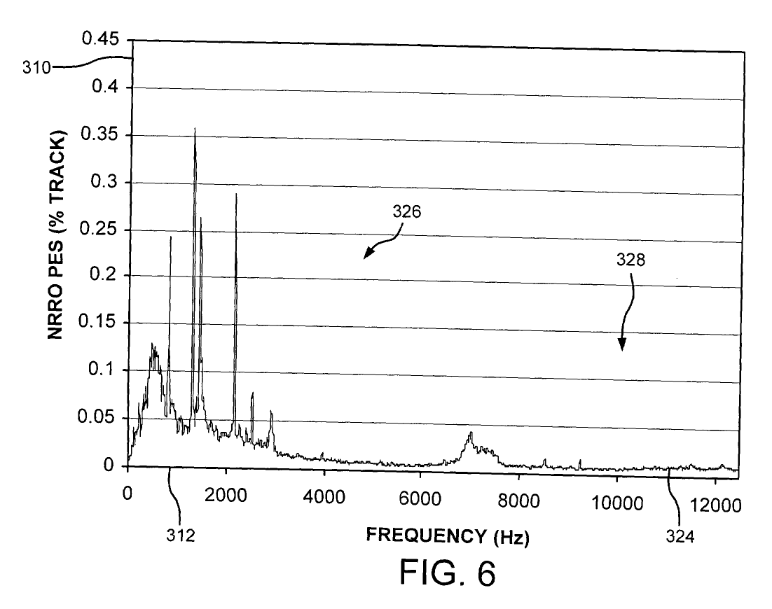

FIG. 6 shows a 5,000 ft magnitude line 324 representing the position error signal of the disc drive 100 operating in a 5,000 ft altitude equivalent pressure environment. At that decreased pressure, the fly height 204 of the head 118 is lower. A low frequency portion 326 of the 5,000 ft magnitude line 324 is similar to the low frequency portion 316 of the sea level magnitude line 314, but with slightly higher peaks. The 5,000 ft magnitude line 324 still includes no noticeable increases in its high frequency portion 328 from 8,000 Hz to above 12,000 Hz. This indicates that the fly height has not decreased enough to cause significant head-disc interference.

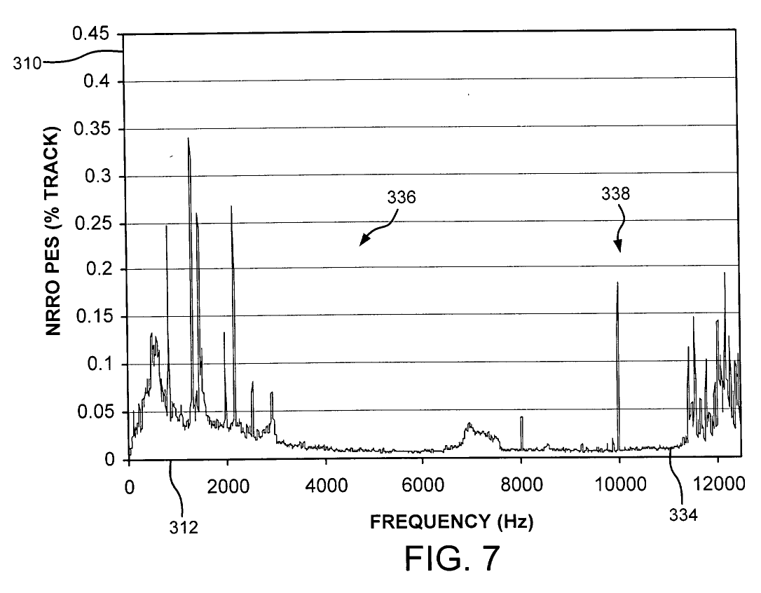

FIG. 7 illustrates a 10,000 ft magnitude line 334 representing the position error signal of the disc drive 100 operating in a 10,000 ft altitude equivalent pressure environment. Again, a low frequency portion 336 of the 10,000 ft magnitude line is similar to the low frequency portions 316 and 326, although with slightly higher peaks. However, the high frequency portion 338 of the 10,000 ft magnitude line defines several peaks around 12,000 Hz. These increases in the high frequency range of the non-repeatable runout component of the position error signal indicate the further decreased fly height in the 10,000 ft altitude equivalent pressure environment has resulted in significant head-disc interference, which has likely excited the high resonant frequencies in the actuator arms and/or flexures.

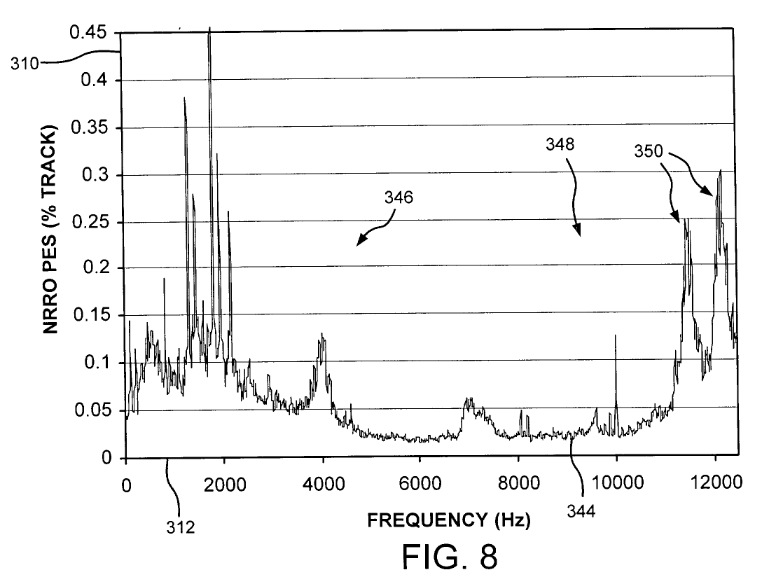

Finally, FIG. 8 illustrates a 13,000 ft magnitude line that represents the position error signal of the disc drive 100 operating at a pressure equivalent to atmospheric pressure at 13,000 ft above sea level. The low frequency portion 346 of the 13,000 ft magnitude line 344 is once again similar to the low frequency portions 316, 326, and 336, although the peaks are higher. However, two large peaks 350 emerge in the high frequency portion 348 above 10,000 Hz. It is believed that each of these peaks corresponds to one of the resonant frequency vibration modes in the actuator arms or flexures, indicating that even more head disc interference is occurring in the 13,000 ft equivalent pressure environment than in the 10,000 ft equivalent pressure environment.

Notably, head-disc interference appears to cause more severe vibrations at the higher resonant frequencies of the actuator arms and/or flexures. However, the lower frequency peaks also appear to increase as the level of head-disc interference increases, though not as dramatically as the higher frequencies.

Several values obtained from the non-repeatable runout component of the position error signal could each be used separately to detect head-disc interference. For example, in a preferred embodiment, a root mean square value of the portion of the signal above 10,000 Hz is calculated and compared to a benchmark value. If the root mean square value exceeds the benchmark value, then the head-disc interference is either significant or unacceptable, depending on the chosen benchmark value. In other words, a relatively low benchmark could be used to detect significant head-disc interference, while a higher benchmark could be used to detect head-disc interference that is not only significant, but also unacceptable. Alternatively, the entire signal could be summed in either the time or frequency domain. Indeed, the peak value at one of the high-frequency resonant modes could be compared to a benchmark value.

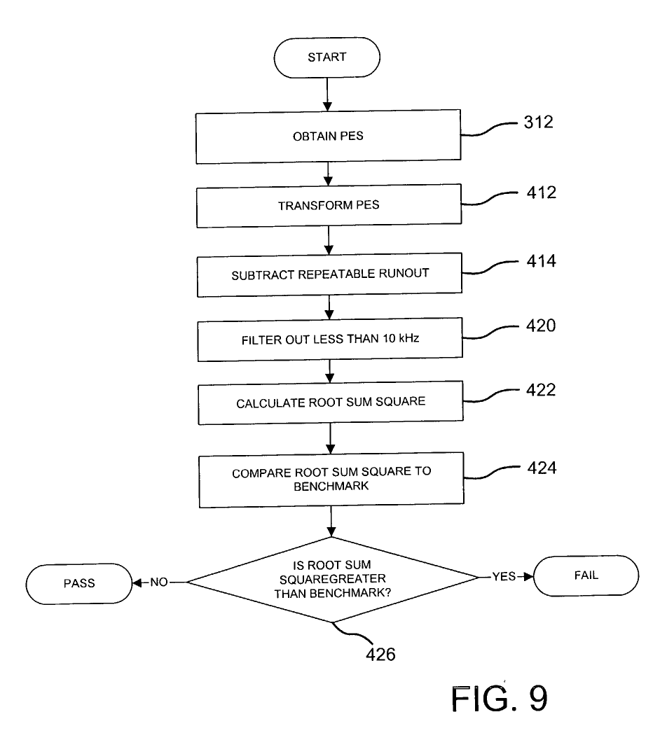

FIG. 9 illustrates a process flow for detecting head-disc interference. In an obtain PES operation 410, a position error signal of the disc drive 100 is obtained. In transform PES operation 412, the position error signal is preferably transformed into the frequency domain, such as by performing a fast Fourier transform on the signal. In subtract repeatable runout operation 414, the repeatable runout component of the position error signal is subtracted from the position error signal to yield the non-repeatable runout component of the position error signal. In high pass filter operation 420, a high pass filter filters out portions of the position error signal that are below a predetermined minimum frequency. Preferably, the predetermined minimum frequency is lower than high frequency peaks that are excited by head-disc interference. In a preferred embodiment, the predetermined minimum frequency is 10,000 Hz so that the resulting signal only includes frequencies above 10,000 Hz. The operations 410, 412, 414, and 420 collectively produce a portion of a frequency domain non-repeatable runout position error signal above a predetermined frequency.

In root sum square operation 422, a root sum square of the peak values in the resulting signal is calculated. In benchmark compare operation 424, the root sum square value is compared to a predetermined benchmark value. The benchmark value is preferably determined such that root sum square values above the benchmark value indicate unacceptable or significant levels of head-disc interference and root sum square values below the benchmark value indicate acceptable or insignificant levels of head-disc interference. In a benchmark query operation 426, it is determined whether the root sum square value calculated in root sum square operation 422 is above or below the benchmark value. If the root sum square value is less than the benchmark value, then the disc drive 100 passes. If the root sum square value is more than the benchmark value, then the disc drive 100 fails. If the disc drive 100 fails, it can be reworked or redesigned as described above, or it can be scrapped.

An embodiment of the present invention may be described as a method of detecting and quantifying head-disc interference in a disc drive (such as 100). The method includes obtaining a position error signal representing deviation of a head (such as 118) from a track on a disc (such as 108) in the disc drive. A portion of the position error signal is analyzed to produce a signal value that corresponds to a level of head-disc interference in the disc drive. The signal value is compared to a predetermined benchmark value, thereby quantifying head-disc interference in the disc drive. Moreover, the method may include designating the disc drive as unacceptable if the signal value is above the predetermined benchmark value.

The analysis of the position error signal may include analyzing a portion of a non-repeatable runout component of the position error signal. Additionally, the analysis may include transforming the position error signal into a frequency domain and analyzing a portion of the frequency domain of the position error signal. Preferably, the portion of the frequency domain is above a predetermined lower frequency limit, which may be about ten thousand Hertz. Moreover, the analysis may include calculating a root sum square of the portion of the position error signal. The method may further include adjusting a preload between the head and the disc surface if the signal value is above the benchmark value.

An embodiment of the present invention may be alternatively described as a method of detecting and quantifying head-disc interference. The method includes obtaining a position error signal representing deviation of a head (such as 118) from a track of a data surface of a disc (such as 108) and isolating a non-repeatable runout component of the position error signal. A portion of the non-repeatable runout component is analyzed to produce a signal value, and the signal value is compared to a predetermined benchmark value, thereby quantifying head-disc interference in the disc drive.

Stated yet another way, an embodiment of the present invention may be alternatively described as a head-disc interference detection system adapted to detect and quantify contact between discs (such as 108) and heads (such as 118) positioned over data surfaces of the discs in disc drives (such as 100). The system includes a disc drive (such as 100) including a disc (such as 108) and a head (such as 118) positioned over a data surface of the disc. The head is able to produce a position error signal representing deviation of the head from a track of the data surface. The detection system is able to analyze magnitudes of the position error signal to produce a signal value. The detection system is also able to compare the signal value to a predetermined benchmark value, thereby quantifying head-disc interference in the disc drive.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, a frequency band, a low pass region, or even the entire position error signal in the time or frequency domain could be summed to yield a position error signal value to be compared to a benchmark value. Numerous other changes may be made which will readily suggest themselves to those skilled in the art and which are encompassed in the spirit of the invention disclosed and as defined in the appended claims.

What is claimed is:

1. A method of detecting and quantifying head-disc interference in a disc drive, the method comprising steps of:
(a) obtaining a position error signal representing deviation of a head from a track on a disc in the disc drive;
(b) analyzing a portion of the position error signal to produce a signal value that corresponds to a level of head-disc interference in the disc drive; and
(c) comparing the signal value to a predetermined benchmark value, thereby quantifying head-disc interference in the disc drive.

2. The method of claim 1, further comprising a step of:
(d) designating the disc drive as unacceptable if the signal value is above the predetermined benchmark value.

3. The method of claim 1, wherein the analyzing step (b) comprises analyzing a portion of a non-repeatable runout component of the position error signal.

4. The method of claim 1, wherein the analyzing step (b) comprises:
(b)(i) transforming the position error signal into a frequency domain; and
(b)(ii) analyzing a portion of the frequency domain of the position error signal.

5. The method of claim 4, wherein the portion of the frequency domain is above a predetermined lower frequency limit.

6. The method of claim 4, wherein the lower limit is about ten thousand Hertz.

7. The method of claim 1, further comprising a step of:
(d) adjusting a preload between the head and the disc surface if the signal value is above the benchmark value.

8. The method of claim 1, wherein the analyzing step (b) comprises calculating a root sum square of the portion of the position error signal.

9. In a disc drive having a disc and a head positioned over a data surface of the disc, a method of detecting and quantifying head-disc interference, the method comprising steps of:
(a) obtaining a position error signal representing deviation of the head from a track of the data surface;
(b) isolating a non-repeatable runout component of the position error signal;
(c) analyzing a portion of the non-repeatable runout component to produce a signal value; and
(d) comparing the signal value to a predetermined benchmark value, thereby quantifying head-disc interference in the disc drive.

10. The method of claim 9, further comprising a step of:
(e) designating the disc drive as unacceptable if the signal value exceeds the benchmark value.

11. The method of claim 9, wherein the analyzing step (c) comprises:
(c)(i) transforming the non-repeatable runout component of the position error signal into a frequency domain; and
(c)(ii) statistically summing magnitudes of the non-repeatable runout component from a portion of the frequency domain.

12. The method of claim 11, wherein the portion of the frequency domain is above a predetermined lower frequency limit.

13. The method of claim 12, wherein the lower limit is about ten thousand Hertz.

14. The method of claim 11, wherein the summing step (c)(ii) comprises calculating a root sum square of the magnitudes of the non-repeatable runout component.

15. The method of claim 9, further comprising:
(e) adjusting a preload between the head and the disc surface if the signal value is above the benchmark value.

16. A head-disc interference detection system adapted to detect and quantify contact between discs and heads positioned over data surfaces of the discs in disc drives, the system comprising:
a disc drive including a disc and a head positioned over a data surface of the disc, the head adapted to produce a position error signal representing deviation of the head from a track of the data surface, wherein the detection system is adapted to analyze magnitudes of the position error signal to produce a signal value and to compare the signal value to a predetermined benchmark value, thereby quantifying head-disc interference in the disc drive.

17. The system of claim 16, wherein a signal value above the predetermined benchmark value indicates an unacceptable level of contact between the head and the disc surface.

18. The system of claim 16, wherein the detection system is adapted to sum magnitudes of a non-repeatable runout portion of the position error signal.

19. The system of claim 16, wherein the detection system is adapted to transform the position error signal into frequency domain and to statistically sum magnitudes from only a portion of the frequency domain that is above a predetermined lower frequency limit.

20. The system of claim 16, wherein the detection system is adapted to decrease a preload between the head and the disc surface if the signal value is above the benchmark value.
